(19) United States
(12) Patent Application Publication
(10) Pub. No.: US 2026/0252659 A1
(43) Pub. Date: Aug. 27, 2026

(54) METHOD AND APPARATUS FOR DISPLAYING RESOURCE CREDENTIAL, DEVICE, STORAGE MEDIUM, AND PROGRAM PRODUCT

(71) Applicant: Beijing Zitiao Network Technology Co., Ltd., Beijing (CN)

(72) Inventor: Ling ZHU, Beijing (CN)

(21) Appl. No.: 19/531,442

(22) Filed: Feb. 5, 2026

(30) Foreign Application Priority Data
Feb. 27, 2025 (CN) 202510228777.1

(51) Int. Cl. G06F 16/957; G06F 16/958

(52) U.S. Cl. CPC G06F 16/9577; G06F 16/958

(57) ABSTRACT

This application discloses a method and an apparatus for displaying a resource credential, a device, a storage medium, and a program product. The method includes: acquiring, in response to a request operation for recommended content, an object identifier and a request channel corresponding to the initiation of the request operation; when the request channel is a card search channel, acquiring a credential resource location corresponding to the object identifier; and if there is a target resource credential available for the recommended content at the credential resource location, displaying the target resource credential on a content card corresponding to the recommended content.

### CROSS-REFERENCE TO RELATED APPLICATIONS

This application claims priority to Chinese Patent Application No. 202510228777.1, entitled “METHOD AND APPARATUS FOR DISPLAYING RESOURCE CREDENTIAL, DEVICE, STORAGE MEDIUM, AND PROGRAM PRODUCT”, and filed on Feb. 27, 2025. The entire disclosure of the prior application is hereby incorporated by reference in its entirety.

### TECHNICAL FIELD

The present disclosure relates to the field of information processing technologies, and in particular, to a method and an apparatus for displaying a resource credential, a device, a storage medium, and a program product.

### BACKGROUND

With the increasing development of the Internet, the e-commerce field has been growing rapidly thanks to the Internet, and is favored by more and more users. However, the structure of the current commodity search card in the e-commerce field is relatively simple, with only personalized questions and commodity card display, lacking the additional display of resource credentials for different groups of people, thus affecting the display effect of the commodity card.

### SUMMARY

In view of this, the present disclosure provides a method and an apparatus for displaying a resource credential, a device, a storage medium, and a program product.

In a first aspect, the present disclosure provides a method for displaying a resource credential, including: acquiring, in response to a request operation for recommended content, an object identifier and a request channel corresponding to initiation of the request operation; acquiring a credential resource location corresponding to the object identifier when the request channel is a card search channel; and displaying, in response to the presence of a target resource credential available for the recommended content at the credential resource location, the target resource credential on a content card corresponding to the recommended content.

In a second aspect, the present disclosure provides an apparatus for displaying a resource credential, including: an identifier acquiring module configured to acquire, in response to a request operation for recommended content, an object identifier and a request channel corresponding to initiation of the request operation; a resource location acquiring module configured to acquire a credential resource location corresponding to the object identifier when the request channel is a card search channel; and a credential display module configured to display, in response to the presence of a target resource credential available for the recommended content at the credential resource location, the target resource credential on a content card corresponding to the recommended content.

In a third aspect, the present disclosure provides a computer device, including: a memory and a processor, where the memory and the processor are communicatively connected to each other, the memory stores computer instructions, and the processor executes the computer instructions to implement the method for displaying a resource credential according to the above first aspect or any implementation corresponding thereto.

In a fourth aspect, the present disclosure provides a computer-readable storage medium storing computer instructions thereon, where the computer instructions are used to cause a computer to implement the method for displaying a resource credential according to the above first aspect or any implementation corresponding thereto.

In a fifth aspect, the present disclosure provides a computer program product including computer instructions, where the computer instructions are used to cause a computer to implement the method for displaying a resource credential according to the above first aspect or any implementation corresponding thereto.

### BRIEF DESCRIPTION OF THE DRAWINGS

In order to more clearly illustrate the technical solutions in the specific embodiments of the present disclosure or in the related art, the following briefly introduces the drawings that need to be used in the description of the specific embodiments or the related art. Obviously, the drawings in the following description are some embodiments of the present disclosure, and for those of ordinary skill in the art, other drawings may also be obtained from these drawings without creative efforts.

FIG. 1 is a schematic flowchart of a method for displaying a resource credential according to an embodiment of the present disclosure;

FIG. 2 is a schematic diagram of displaying a resource credential according to an embodiment of the present disclosure;

FIG. 3 is a schematic flowchart of another method for displaying a resource credential according to an embodiment of the present disclosure;

FIG. 4 is another schematic diagram of displaying a resource credential according to an embodiment of the present disclosure;

FIG. 5 is a schematic diagram of displaying a resource credential on a landing page according to an embodiment of the present disclosure;

FIG. 6 is another schematic diagram of displaying a resource credential on a landing page according to an embodiment of the present disclosure;

FIG. 7 is a schematic flowchart of another method for displaying a resource credential according to an embodiment of the present disclosure;

FIG. 8 is a schematic diagram of displaying recommended content according to an embodiment of the present disclosure;

FIG. 9 is a schematic flowchart of a specific implementation of displaying a resource credential according to an embodiment of the present disclosure;

FIG. 10 is a structural block diagram of an apparatus for displaying a resource credential according to an embodiment of the present disclosure; and

FIG. 11 is a schematic hardware structural diagram of a computer device according to an embodiment of the present disclosure.

### DETAILED DESCRIPTION OF EMBODIMENTS

In order to make the purposes, technical solutions, and advantages of the embodiments of the present disclosure clearer, the technical solutions in the embodiments of the present disclosure will be described clearly and comprehensively below with reference to the drawings in the embodiments of the present disclosure. Obviously, the described embodiments are part of the embodiments of the present disclosure, but not all of the embodiments. Based on the embodiments in the present disclosure, all other embodiments obtained by those skilled in the art without creative efforts belong to the protection scope of the present disclosure.

It may be understood that before using the technical solutions disclosed in the embodiments of the present disclosure, it is necessary to inform the user of the type, range of use, use scenarios, etc. of personal information involved in the present disclosure and to obtain the authorization of the user in an appropriate manner in accordance with relevant laws and regulations.

For example, in response to receiving an active request from a user, prompt information is sent to the user to clearly prompt the user that the requested operation will require access to and use of the user's personal information. In this way, the user may independently choose, based on the prompt information, whether to provide personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select “agree” or “disagree” to provide the personal information to the electronic device.

It may be understood that the above process of notifying and obtaining user authorization is only illustrative and does not limit the implementations of the present disclosure, and other methods that satisfy the relevant laws and regulations may also be applied to the implementations of the present disclosure.

It may be understood that the data involved in this technical solution (including but not limited to the data itself, acquisition or use of the data) should comply with the requirements of corresponding laws, regulations, and related provisions.

At present, the structure of a commodity search card in the e-commerce field is relatively simple, with only personalized questions and commodity card display, lacking the additional display of resource credentials for different groups of people, which affects the display effect of the commodity card, and is not conducive to the improvement of card access volume and the rapid conversion after a user's search.

In view of this, the present disclosure provides a method and an apparatus for displaying a resource credential, a device, a storage medium, and a program product to solve the problem of poor display effect caused by the lack of additional credential for a commodity card.

In the technical solution of the present disclosure, a resource credential is inserted into a content card for display, which enriches the display information on the content card, and is convenient to attract the user to pay attention to recommended content, thereby promoting the conversion rate of the recommended content.

According to the method and the apparatus for displaying a resource credential, the device, the storage medium, and the program product provided by the present disclosure, in response to the request operation initiated by a user for the recommended content, the object identifier and the request channel for initiating the request operation are acquired, and the credential resource location corresponding to the object identifier is acquired when the request channel is the card search channel, so that the credential resource location may be acquired for different groups of people. When there is the target resource credential available for the recommended content at the credential resource location, the target resource credential is displayed on the content card corresponding to the recommended content, which realizes displaying the resource credential on the content card, improves the display effect of the content card, and enriches the display information on the content card. At the same time, because the credential resource location is acquired for different groups of people, the target resource credential existing at the credential resource location may match the corresponding object identifier, which ensures the matching degree between the target resource credential and the object identifier, thereby realizing addition of resource credentials for different groups of people, and being favorable for attracting the user to pay attention to the recommended content and promoting the conversion rate of the recommended content.

According to an embodiment of the present disclosure, an embodiment of a method for displaying a resource credential is provided. It should be noted that the steps shown in the flowchart of the drawings may be executed in a computer system such as a set of computer executable instructions, and although a logical order is shown in the flowchart, in some cases, the shown or described steps may be executed in an order different from that here.

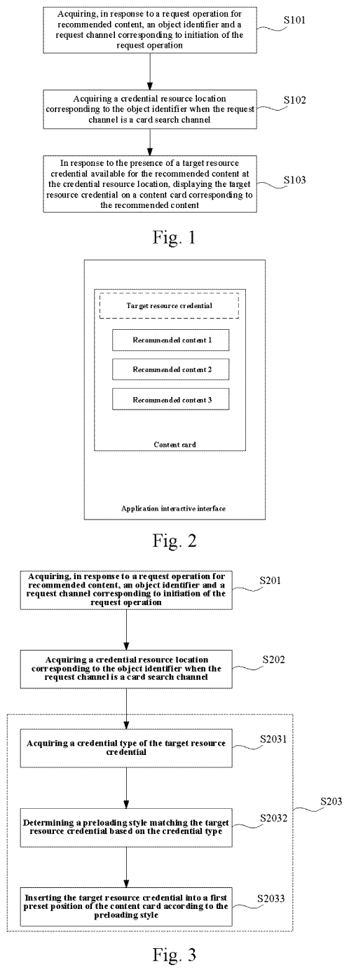

In this embodiment, a method for displaying a resource credential is provided, which may be applied to computer devices, such as mobile phones, tablets, computers, etc. FIG. 1 is a flowchart of a method for displaying a resource credential according to an embodiment of the present disclosure. As shown in FIG. 1, the process includes the following steps:
Step S101: acquiring, in response to a request operation for recommended content, an object identifier and a request channel corresponding to initiation of the request operation.

The recommended content is the content displayed on an interactive interface of an application, such as commodity recommendations for clothes, daily necessities, etc. The request operation is an operation triggered by a user for the recommended content when browsing the recommended content. The object identifier is used to represent a target user who triggers the recommended content, and the object identifier is used to represent the identity of the object. The request channel is a channel through which the target user initiates the request operation.

Specifically, as shown in FIG. 2, when browsing the recommended content displayed on the current page, the user may click on a commodity displayed in the recommended content to request to view specific information of the commodity. Correspondingly, the current page is the request channel, and the current page may respond to the request operation initiated by the user for the recommended content, and acquire the object identifier corresponding to the user.
Step S102: acquiring a credential resource location corresponding to the object identifier when the request channel is a card search channel.

The card search channel represents that the request operation is triggered from a card display interface of the recommended content, and the card display interface displays the recommended content in the form of a card. The credential resource location is used to store resource credentials existing for the recommended content, such as commodity additional issuance coupons, commodity public coupons, and the like. When a request is initiated through the card search channel, the application reads the credential resource location corresponding to the object identifier through a corresponding request interface and the object identifier, to acquire resource credential data existing at the credential resource location.
Step S103: displaying, in response to the presence of a target resource credential available for the recommended content at the credential resource location, the target resource credential on a content card corresponding to the recommended content.

The target resource credential is a to-be-received resource credential that matches the recommended content. After the user successfully receives the target resource credential, the target resource credential becomes a to-be-used resource credential, and the target resource credential is an additional issuance resource credential. It is determined whether there is currently an available target resource credential by parsing the resource credential data existing at the credential resource location. If there is the target resource credential available for the recommended content at the credential resource location, the target resource credential is inserted into the content card of the recommended content for display, so that the user may view the target resource credential in time and receive and use the target resource credential according to the demand.

According to the method for displaying a resource credential provided by this embodiment, in response to the request operation initiated by the user for the recommended content, the object identifier and the request channel for initiating the request operation are acquired, and the credential resource location corresponding to the object identifier is acquired when the request channel is the card search channel, so that the credential resource location may be acquired for different groups of people. When there is the target resource credential available for the recommended content at the credential resource location, the target resource credential is displayed on the content card corresponding to the recommended content, which realizes displaying the resource credential on the content card, improves the display effect of the content card, and enriches the display information on the content card. At the same time, because the credential resource location is acquired for different groups of people, the target resource credential existing at the credential resource location may match the corresponding object identifier, which ensures the matching degree between the target resource credential and the object identifier, thereby realizing addition of resource credentials for different groups of people, and being favorable for attracting the user to pay attention to the recommended content and promoting the conversion rate of the recommended content.

In this embodiment, a method for displaying a resource credential is provided, which may be applied to computer devices, such as mobile phones, tablets, computers, etc. FIG. 3 is a flowchart of a method for displaying a resource credential according to an embodiment of the present disclosure. As shown in FIG. 3, the process includes the following steps:
Step S201: acquiring, in response to a request operation for recommended content, an object identifier and a request channel corresponding to initiation of the request operation. For details, please refer to the relevant description of the corresponding step in the embodiment shown above, which will not be repeated here.
Step S202: acquiring a credential resource location corresponding to the object identifier when the request channel is a card search channel. For details, please refer to the relevant description of the corresponding step in the embodiment shown above, which will not be repeated here.
Step S203: displaying, in response to the presence of a target resource credential available for the recommended content at the credential resource location, the target resource credential on a content card corresponding to the recommended content.

Specifically, the above step S203 includes:
Step S2031: acquiring a credential type of the target resource credential.

The credential type represents an attribute that the target resource credential has when used, such as a postage credential, a commodity discount credential, and the like. Specifically, the credential type of the resource credential may be identified by a type attribute, that is, different credential types have different type attributes. Therefore, when it is determined that there is an available target resource credential, the type attribute of the target resource credential may be parsed, and the credential type to which the target resource credential belongs may be determined through the type attribute.
Step S2032: determining a preloading style matching the target resource credential based on the credential type.

The preloading style represents preloading style resources, such as pictures, layouts, etc., necessary for generating the target resource credential. Specifically, for different types of resource credentials, corresponding display forms may be preset, and a matching relationship between the credential type and the display form may be established. When preloading is required for the target resource credential, the preloading style matching the target resource credential may be determined according to the matching relationship between the credential type and the display form.
Step S2033: inserting the target resource credential into a first preset position of the content card according to the preloading style.

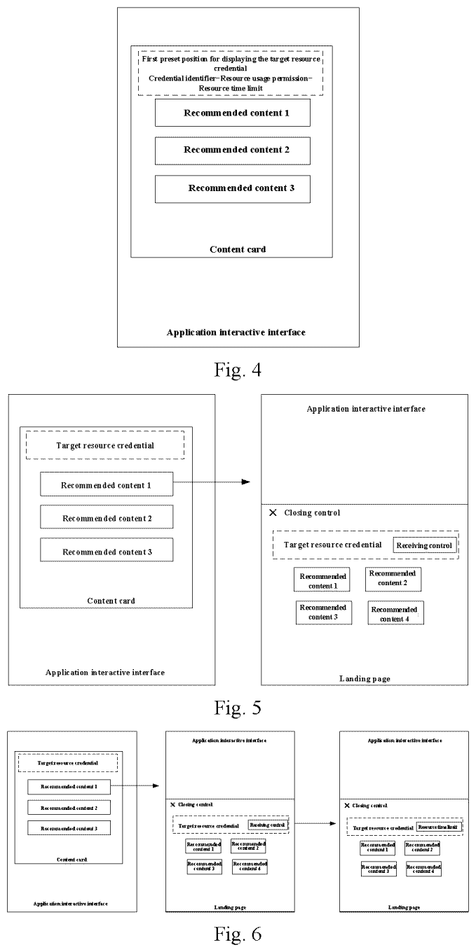

The first preset position is a preset display position of the target resource credential on the content card, for example, the first preset position is displayed at the top of the content card, as shown in FIG. 4. In order to ensure that the user may view the relevant information of the target resource credential, when it is determined that there is the target resource credential available for the recommended content at the credential resource location, the target resource credential may be rendered according to the preloading style and inserted into the first preset position on the content card for display.

According to the method for displaying a resource credential provided by this embodiment, the corresponding preloading style is determined through the credential type of the target resource credential, so as to display the target resource credential according to the preloading style, thereby improving the loading speed of the target resource credential in the content card and the user experience.

In some optional implementations, the above method further includes: displaying a resource usage permission and a resource time limit corresponding to the target resource credential on the content card. The resource usage permission is used to define a usage condition of the target resource credential, and the resource time limit is used to define an available time of the target resource credential.

When the target resource credential is displayed at the first preset position on the content card, an area where the first preset position is located on the content card is determined, and the resource usage permission and the resource time limit of the target resource credential are synchronously displayed in the area, as shown in FIG. 4.

The method for displaying a resource credential provided by this embodiment supports displaying the resource usage permission and the resource time limit, to ensure that the user may learn the usage information of the target resource credential, thereby realizing strengthening of resource usage information and an urging state corresponding to the target resource credential.

In some optional implementations, the above method further includes: displaying, in response to a trigger operation for the content card, a landing page corresponding to the content card, and inserting the target resource credential into a second preset position of the landing page.

The second preset position is a display position of the target resource credential on the landing page, for example, the second preset position is displayed below a search control. The landing page is used to display key information of the recommended content in the content card, and the landing page may be displayed in a style of 70% screen, half screen, or full screen, which is not specifically limited here. As shown in FIG. 5, when the user views the presence of the target resource credential in the content card, the user may click on the content card to enter the landing page that displays the recommended content, and the target resource credential will be forcibly inserted from the content card into the landing page with the switching of the page.

The method for displaying a resource credential provided by this embodiment supports that the target resource credential is forcibly inserted and displayed on the landing page, ensures that the target resource credential has the highest priority in the current card search channel, and realizes preferential display of the target resource credential in the card search channel.

In some optional implementations, the above method further includes: associating, in response to a credential receiving operation initiated on the landing page, the target resource credential with the object identifier based on the credential receiving operation.

A receiving control for the target resource credential is set on the landing page, and the receiving operation is an operation in which the user triggers the receiving control to receive the target resource credential. The user may receive the target resource credential to be received that is displayed on the landing page. Correspondingly, the receiving control on the landing page may respond to the trigger operation of the user. If the target resource credential is successfully received, the target resource credential is associated with the object identifier of the user, the receiving control is no longer displayed on the landing page, and the resource time limit of the target resource credential is displayed in the area where the second preset position is located, as shown in FIG. 6.

The method for displaying a resource credential provided by this embodiment supports receiving the target resource credential on the landing page, so that the target resource credential may be received flexibly, which improves the click through rate of the user on the target resource credential, and is favorable for promoting the conversion of the recommended content under the target resource credential.

In some optional implementations, the above method further includes: returning to a display page of the recommended content in response to a closing operation for the landing page.

A closing control is set on the landing page, and the closing operation is an operation in which the user triggers the closing control. As shown in FIGS. 5 and 6, when the user needs to close the landing page, the user may click on the closing control, and correspondingly, the landing page may respond to the closing operation of the user, exit, and return to the display page of the recommended content. The display page may be a search homepage or a card display page of the recommended content, which is not specifically limited here.

The method for displaying a resource credential provided by this embodiment supports closing the landing page and returning to the display page of the recommended content, improves the flexible switching of the landing page, and ensures the user experience.

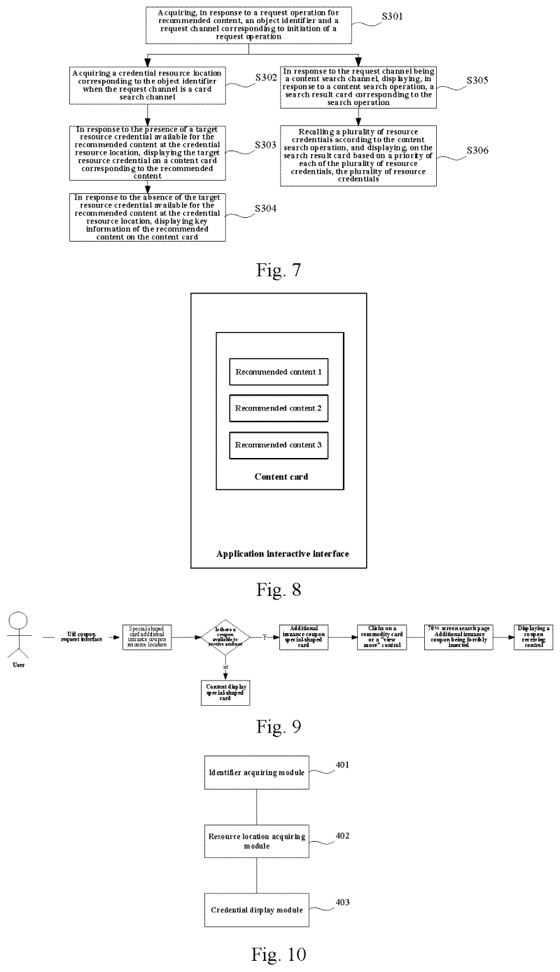

In this embodiment, a method for displaying a resource credential is provided, which may be used for computer devices, such as mobile phones, tablets, computers, etc. FIG. 7 is a flowchart of a method for displaying a resource credential according to an embodiment of the present disclosure. As shown in FIG. 7, the process includes the following steps:
Step S301: acquiring, in response to a request operation for recommended content, an object identifier and a request channel corresponding to initiation of the request operation. For details, please refer to the relevant description of the corresponding step in the embodiment shown above, which will not be repeated here.
Step S302: acquiring a credential resource location corresponding to the object identifier when the request channel is a card search channel. For details, please refer to the relevant description of the corresponding step in the embodiment shown above, which will not be repeated here.
Step S303: displaying, in response to the presence of a target resource credential available for the recommended content at the credential resource location, the target resource credential on a content card corresponding to the recommended content. For details, please refer to the relevant description of the corresponding step in the embodiment shown above, which will not be repeated here.
Step S304: displaying, in response to the absence of the target resource credential available for the recommended content at the credential resource location, key information of the recommended content on the content card.

The key information represents important relevant information of the recommended content, such as a commodity name, commodity description information, commodity price, and the like. If it is determined by parsing the resource credential data existing at the credential resource location that there is currently no available target resource credential at the credential resource location, the key information of the recommended content may be directly displayed on the content card, as shown in FIG. 8.

Step S305: displaying, in response to a content search operation, a search result card corresponding to the content search operation when the request channel is a content search channel.

The content search channel represents that the request operation is triggered from a search interface, such as the search homepage. That is, the request operation is not triggered from the card display interface. Specifically, the search interface is provided with a search control and a search box, and the content search operation is an operation in which the user inputs search content and triggers the search control. When the user inputs search content of interest in the search box, the user may click on the search control to perform content search. Correspondingly, the search control in the search interface may respond to the content search operation of the user, return a corresponding query result according to a content search request corresponding to the content search operation, and display the query result in the form of the search result card.
Step S306: recalling a plurality of resource credentials according to the content search operation, and displaying, on the search result card based on a priority of each of the plurality of resource credentials, the plurality of resource credentials.

When the content search is performed from the search interface, a plurality of resource credentials associated with the search result corresponding to the content search operation may be recalled from the search universe, specifically including a resource delivery credential (which contains visual elements (such as pictures, animations) and a brief description that attract the user), a public interface query credential (which may be obtained by querying a public application programming interface), and an additional issuance resource credential (i.e., the target resource credential described in the above embodiment).

Resource credentials from different sources have different priorities, and the resource credentials are sorted according to the priorities as follows: the resource delivery credential, the public interface query credential, and the additional issuance resource credential. For the plurality of recalled resource credentials, the resource credentials are displayed in the search result card in the search interface according to the priorities of the resource credentials. Specifically, if the resource delivery credential, the public interface query credential, and the additional issuance resource credential exist at the same time, the resource delivery credential is preferentially displayed; if only the public interface query credential and the additional issuance resource credential exist, the public interface query credential is preferentially displayed; and if only the additional issuance resource credential exists, the additional issuance resource credential is displayed.

According to the method for displaying a resource credential provided by this embodiment, when the acquisition of the resource credential is triggered through the content search channel, the plurality of recalled resource credentials are displayed on the search result card according to the priority of each of the plurality of resource credentials, to maximize the cost savings of additional issuance of resource credentials.

As a specific example of the embodiments of the present disclosure, taking an additional issuance coupon as an example, the above method is described in conjunction with the flowchart shown in FIG. 9. When the user searches for the additional issuance coupon through a “for-you” content recommendation interface, in combination with the user's object identifier uid coupon request interface, a special-shaped card additional issuance coupon resource location associated with the object identifier is acquired. It is detected whether there is a coupon available to receive and use at the special-shaped card additional issuance coupon resource location. If there is a coupon available to receive and use, the additional issuance coupon is inserted into the special-shaped card, to obtain an additional issuance coupon special-shaped card that displays the additional issuance coupon. If there is no coupon available to receive and use, a special-shaped card of the recommended content is displayed. When the user clicks on a commodity card or a “view more” control in the additional issuance coupon special-shaped card, the current content recommendation interface is switched to a 70% screen search page that displays commodity information, and the additional issuance coupon is forcibly inserted into the 70% screen search page, to strengthen the display of the additional issuance coupon, and the display form of the additional issuance coupon is determined based on the corresponding coupon type thereof (for example, a postage coupon is displayed in blue, a commodity coupon is displayed in red, etc.).

When the user does not receive the additional issuance coupon, a coupon receiving control is displayed on the 70% screen for the user to trigger receiving. When the user completes receiving the additional issuance coupon, time limit information of the additional issuance coupon is displayed on the 70% screen to remind the user to use the additional issuance coupon as soon as possible.

In this embodiment, an apparatus for displaying a resource credential is further provided, and the apparatus is used to implement the above embodiments and preferred implementations, those already explained will not be repeated here. As used below, the term “module” may implement a combination of software and/or hardware for a predetermined function. Although the apparatus described in the following embodiments is preferably implemented in software, implementation in hardware, or a combination of software and hardware is also possible and contemplated.

This embodiment provides an apparatus for displaying a resource credential, as shown in FIG. 10, including:
an identifier acquiring module 401 configured to acquire, in response to a request operation for recommended content, an object identifier and a request channel corresponding to initiation of the request operation;
a resource location acquiring module 402 configured to acquire a credential resource location corresponding to the object identifier when the request channel is a card search channel; and
a credential display module 403 configured to display, in response to the presence of a target resource credential available for the recommended content at the credential resource location, the target resource credential on a content card corresponding to the recommended content.

In some optional implementations, the credential display module 403 includes:
a type acquiring unit configured to acquire a credential type of the target resource credential;
a preloading style determining unit configured to determine a preloading style matching the target resource credential based on the credential type; and
an inserting unit configured to insert the target resource credential into a first preset position of the content card according to the preloading style.

In some optional implementations, the above credential display module 403 further includes:
a resource information display unit configured to display a resource usage permission and a resource time limit corresponding to the target resource credential on the content card. The resource usage permission is used to define a usage condition of the target resource credential, and the resource time limit is used to define an available time of the target resource credential.

In some optional implementations, the above credential display module 403 further includes:
a landing display unit configured to display, in response to a trigger operation for the content card, a landing page corresponding to the content card, and insert the target resource credential into a second preset position of the landing page.

In some optional implementations, the above credential display module 403 further includes:
a receiving unit configured to associate, in response to a credential receiving operation initiated on the landing page, the target resource credential with the object identifier based on the credential receiving operation.

In some optional implementations, the above credential display module 403 further includes:
a page closing unit configured to return to a display page of the recommended content in response to a closing operation for the landing page.

In some optional implementations, the above apparatus further includes:
a key information display module configured to display, in response to the absence of the target resource credential available for the recommended content at the credential resource location, key information of the recommended content on the content card.

In some optional implementations, the above apparatus further includes:
a search module configured to display, in response to a content search operation, a search result card corresponding to the content search operation when the request channel is a content search channel; and
a priority module configured to recall a plurality of resource credentials according to the content search operation, and display, on the search result card based on a priority of each of the plurality of resource credentials, the plurality of resource credentials.

Further functional descriptions of each of the above modules and units are the same as those in the corresponding embodiments above, and will not be repeated here.

The apparatus for displaying a resource credential in this embodiment is presented in the form of a functional unit, and the unit here refers to an application specific integrated circuit (ASIC) circuit, a processor and a memory that execute one or more software or fixed programs, and/or other devices that may provide the above functions.

According to the apparatus for displaying a resource credential provided by this embodiment, in response to the request operation initiated by the user for the recommended content, the object identifier and the request channel for initiating the request operation are acquired, and the credential resource location corresponding to the object identifier is acquired when the request channel is the card search channel, so that the credential resource location may be acquired for different groups of people. When there is the target resource credential available for the recommended content at the credential resource location, the target resource credential is displayed on the content card corresponding to the recommended content, which realizes displaying the resource credential on the content card, improves the display effect of the content card, and enriches the display information on the content card. At the same time, because the credential resource location is acquired for different groups of people, the target resource credential existing at the credential resource location may match the corresponding object identifier, which ensures the matching degree between the target resource credential and the object identifier, thereby realizing addition of resource credentials for different groups of people, and being favorable for attracting the user to pay attention to the recommended content and promoting the conversion rate of the recommended content.

An embodiment of the present disclosure further provides a computer device having the apparatus for displaying a resource credential shown in FIG. 10 above.

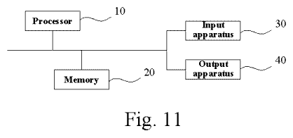

Referring to FIG. 11, FIG. 11 is a schematic structural diagram of a computer device provided by an optional embodiment of the present disclosure. As shown in FIG. 11, the computer device includes: one or more processors 10, a memory 20, and interfaces for connecting various components, including high-speed interfaces and low-speed interfaces. The components communicate with each other using different buses and may be installed on a common main board or in other ways as needed. The processor may process instructions executed within the computer device, including instructions stored in or on the memory to display graphical information of GUI on an external input/output apparatus (such as a display device coupled to the interface). In some optional implementations, if required, multiple processors and/or buses may be used with multiple memories. Similarly, multiple computer devices may be connected, and each device provides some necessary operations (for example, as a server array, a group of blade servers, or a multi-processor system). In FIG. 11, one processor 10 is taken as an example.

The processor 10 may be a central processing unit, a network processor, or a combination thereof. The processor 10 may further include a hardware chip. The hardware chip may be an application specific integrated circuit, a programmable logic device, or a combination thereof. The programmable logic device may be a complex programmable logic device, a field programmable logic gate array, a generic array logic, or any combination thereof.

The memory 20 stores instructions executable by at least one processor 10, so that the at least one processor 10 executes the method shown in the above embodiments.

The memory 20 may include a program storage area and a data storage area, where the program storage area may store an application program required by an operating system and at least one function; and the data storage area may store data created according to the use of the computer device, and the like. In addition, the memory 20 may include a high-speed random access memory or a non-transitory memory, such as at least one magnetic disk storage device, a flash memory device, or other non-transitory solid-state storage devices. In some optional implementations, the memory 20 optionally includes memories remotely provided with respect to the processor 10, and these remote memories may be connected to the computer device through a network. Examples of the above network include, but are not limited to, internet, an intranet, a local area network, a mobile communication network, and a combination thereof.

The memory 20 may include a volatile memory, such as a random access memory, or may include a non-volatile memory, such as a flash memory, a hard disk or a solid state disk, or the memory 20 may also include a combination of the above kinds of memories.

The computer device further includes an input apparatus 30 and an output apparatus 40. The processor 10, the memory 20, the input apparatus 30, and the output apparatus 40 may be connected through a bus or in other ways. In FIG. 11, connection through a bus is taken as an example.

The input apparatus 30 may receive input digital or character information, and generate a key signal input related to user settings and function control of the computer device, such as a touch screen, a keypad, a mouse, a track pad, a touch panel, an indicator stick, one or more mouse buttons, a trackball, a joystick, etc. The output apparatus 40 may include a display device, an auxiliary lighting apparatus (such as an LED), a tactile feedback apparatus (such as a vibration motor), and the like. The above display device includes, but is not limited to, a liquid crystal display, a light emitting diode, a display, and a plasma display. In some optional implementations, the display device may be a touch screen.

The computer device further includes a communication interface for the computer device to communicate with other devices or communication networks.

An embodiment of the present disclosure further provides a computer-readable storage medium. The method according to the embodiments of the present disclosure may be implemented in hardware and firmware, or implemented as computer codes that may be recorded in a storage medium or originally stored in a remote storage medium or a non-transitory machine-readable storage medium downloaded through a network and to be stored in a local storage medium, so that the method described here may be stored in such software processing on a storage medium using a general-purpose computer, a dedicated processor, or programmable or dedicated hardware. The storage medium may be a magnetic disk, an optical disk, a read-only memory, a random access memory, a flash memory, a hard disk, or a solid-state disk, etc. Further, the storage medium may also include a combination of the above kinds of memories. It may be understood that the computer, the processor, the microprocessor controller or the programmable hardware includes a storage component that may store or receive software or computer codes, and when the software or computer codes are accessed and executed by the computer, the processor or the hardware, the method shown in the above embodiments is implemented.

A part of the present disclosure may be applied as a computer program product, such as computer program instructions, which, when executed by a computer, may invoke or provide the method and/or technical solution according to the present disclosure through the operation of the computer. Those skilled in the art should understand that the computer program instructions exist in the computer-readable medium in forms including but not limited to source files, executable files, installation package files, etc. Accordingly, the computer program instructions are executed by the computer in manners including but not limited to: the computer directly executes the instructions, or the computer compiles the instructions and then executes the corresponding compiled program, or the computer reads and executes the instructions, or the computer reads and installs the instructions and then executes the corresponding installed program. Here, the computer-readable medium may be any available computer-readable storage medium or communication medium accessible by the computer.

Although the embodiments of the present disclosure are described in conjunction with the drawings, those skilled in the art may make various modifications and variations without departing from the spirit and scope of the present disclosure, and such modifications and variations fall within the scope defined by the appended claims.

1. A method for displaying a resource credential, comprising:
acquiring, in response to a request operation for recommended content, an object identifier and a request channel corresponding to initiation of the request operation ;
acquiring a credential resource location corresponding to the object identifier when the request channel is a card search channel; and
in response to a target resource credential available for the recommended content being present at the credential resource location, displaying the target resource credential on a content card corresponding to the recommended content.

2. The method of claim 1, wherein the displaying the target resource credential on the content card corresponding to the recommended content comprises:
acquiring a credential type of the target resource credential;
determining a preloading style matching the target resource credential based on the credential type; and
inserting the target resource credential into a first preset position of the content card according to the preloading style.

3. The method of claim 2, further comprising:
displaying a resource usage permission and a resource time limit corresponding to the target resource credential on the content card, wherein the resource usage permission is used to define a usage condition of the target resource credential, and the resource time limit is used to define an available time of the target resource credential.

4. The method of claim 2, further comprising:
in response to a trigger operation for the content card, displaying a landing page corresponding to the content card, and inserting the target resource credential into a second preset position of the landing page.

5. The method of claim 4, further comprising:
in response to a credential receiving operation initiated on the landing page, associating the target resource credential with the object identifier based on the credential receiving operation.

6. The method of claim 4, further comprising:
in response to a closing operation for the landing page, returning to a display page of the recommended content.

7. The method of claim 1, further comprising:
in response to the request channel being a content search channel, displaying, in response to a content search operation, a search result card corresponding to the content search operation; and
recalling a plurality of resource credentials according to the search operation, and displaying, on the search result card based on a priority of each of the plurality of resource credentials, the plurality of resource credentials.

8. The method of claim 1, further comprising:
in response to the target resource credential available for the recommended content being absent at the credential resource location, displaying key information of the recommended content on the content card.

9. A computer device, comprising:
a memory and a processor, wherein the memory and the processor are communicatively connected to each other, the memory stores computer instructions, and the processor executes the computer instructions to implement a method for displaying a resource credential, comprising:
acquiring, in response to a request operation for recommended content, an object identifier and a request channel corresponding to initiation of the request operation;
acquiring a credential resource location corresponding to the object identifier when the request channel is a card search channel; and
in response to a target resource credential available for the recommended content being present at the credential resource location, displaying the target resource credential on a content card corresponding to the recommended content.

10. The computer device of claim 9, wherein the displaying the target resource credential on the content card corresponding to the recommended content comprises:
acquiring a credential type of the target resource credential;
determining a preloading style matching the target resource credential based on the credential type; and
inserting the target resource credential into a first preset position of the content card according to the preloading style.

11. The computer device of claim 10, wherein the method for displaying the resource credential further comprises:
displaying a resource usage permission and a resource time limit corresponding to the target resource credential on the content card, wherein the resource usage permission is used to define a usage condition of the target resource credential, and the resource time limit is used to define an available time of the target resource credential.

12. The computer device of claim 10, wherein the method for displaying the resource credential further comprises:
in response to a trigger operation for the content card, displaying a landing page corresponding to the content card, and inserting the target resource credential into a second preset position of the landing page.

13. The computer device of claim 12, wherein the method for displaying the resource credential further comprises:
in response to a credential receiving operation initiated on the landing page, associating the target resource credential with the object identifier based on the credential receiving operation.

14. The computer device of claim 12, wherein the method for displaying the resource credential further comprises:
in response to a closing operation for the landing page, returning to a display page of the recommended content.

15. The computer device of claim 9, wherein the method for displaying the resource credential further comprises:
in response to the request channel being a content search channel, displaying, in response to a content search operation, a search result card corresponding to the content search operation; and
recalling a plurality of resource credentials according to the search operation, and displaying, on the search result card based on a priority of each of the plurality of resource credentials, the plurality of resource credentials.

16. The computer device of claim 9, wherein the method for displaying the resource credential further comprises:
in response to the target resource credential available for the recommended content being absent at the credential resource location, displaying key information of the recommended content on the content card.

17. A non-transitory computer-readable storage medium storing computer instructions thereon, wherein the computer instructions are used to cause a computer to implement a method for displaying a resource credential, comprising:
acquiring, in response to a request operation for recommended content, an object identifier and a request channel corresponding to initiation of the request operation;
acquiring a credential resource location corresponding to the object identifier when the request channel is a card search channel; and
in response to a target resource credential available for the recommended content being present at the credential resource location, displaying the target resource credential on a content card corresponding to the recommended content.

18. The non-transitory computer-readable storage medium of claim 17, wherein the displaying the target resource credential on the content card corresponding to the recommended content comprises:
acquiring a credential type of the target resource credential;
determining a preloading style matching the target resource credential based on the credential type; and
inserting the target resource credential into a first preset position of the content card according to the preloading style.

19. The non-transitory computer-readable storage medium of claim 18, wherein the method for displaying the resource credential further comprises:
displaying a resource usage permission and a resource time limit corresponding to the target resource credential on the content card, wherein the resource usage permission is used to define a usage condition of the target resource credential, and the resource time limit is used to define an available time of the target resource credential.

20. The non-transitory computer-readable storage medium of claim 18, wherein the method for displaying the resource credential further comprises:
in response to a trigger operation for the content card, displaying a landing page corresponding to the content card, and inserting the target resource credential into a second preset position of the landing page.
